(19) United States
(12) Patent Application Publication
(10) Pub. No.: US 2014/0082076 A1
(43) Pub. Date: Mar. 20, 2014

(54) SIMULTANEOUS DATA PRESENTATION MECHANISM

(71) Applicant: Richard George Hoptroff, London (GB)

(72) Inventor: Richard George Hoptroff, London (GB)

(21) Appl. No.: 14/022,426

(22) Filed: Sep. 10, 2013

(30) Foreign Application Priority Data
Sep. 14, 2012 (GB) 1216477.8

(51) Int. Cl. H04L 29/08

(52) U.S. Cl. CPC H04L 67/1095
USPC 709/204

(57) ABSTRACT

This invention relates to a method for broadcasting the same information from one server (101, FIG. 1) to users in multiple internet sessions such that it appears simultaneously on all browser screens (102, 103).

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

This invention relates to a method for broadcasting the same information from one server (101, FIG. 1) to users in multiple internet sessions such that it appears simultaneously on all browser screens (102, 103).

Certain multi-user internet applications require information to be distributed to users such that such that it appears simultaneously on all browser screens. An example is an online voting application, where the voting time window must be the same for all users, or as close as possible thereto.

A simple browser-based solution is to use browser-side Javascript code to poll a web server occasionally for new information to display. The simultaneity of information displayed with such a method is limited to the rate at which the browsers poll the servers.

### BRIEF SUMMARY

The state of the art is the use of push technologies such as WebSockets to provide a closer to real-time display. It does this by allowing the server to push the information at the appropriate time to all web browsers without waiting to be polled. While closer to achieving simultaneity, it has limitations; first, it requires special application software to be installed on the server and the browsers; second, a multitasking server supporting multiple users can only send a message to one browser at a time, so the simultaneity is inherently limited.

According to a first aspect of the invention, there is provided a method of sending a message between an Internet connectable server and client, the message to be displayed at a particular time, the method comprising the steps of: the server receiving a first polling message from a first client; the server, in response to receiving the first polling message, calculates a first time delay for a first message, and sends the first message to the first client, the first message including an indication of the first time delay; and the first client, in response to receiving the first message, causes the first message to be displayed on expiry of the first time delay.

According to a second aspect of the invention, there is provided an Internet connectable server as claimed in claim 8. According to a third aspect of the invention, there is provided an Internet connectable client as claimed in claim 14.

The current invention achieves a high degree of simultaneity as follows:

1. At a point in time before information must simultaneously be displayed on all user screens, the server enters a state where the information it transmits to each client is an instruction to display information at some time in the future.

2. The server remains in this state long enough to ensure that the instruction reaches all clients.
3. At the appointed time in the future, all client devices simultaneously display the information as instructed.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a prior art method for broadcasting the same information from one server to users;

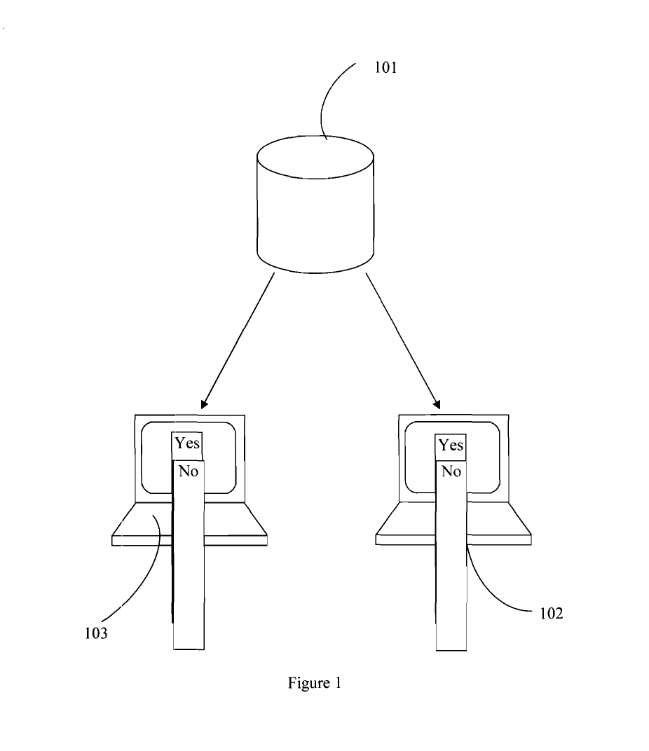

FIG. 2 illustrates a first embodiment of the present invention; and

FIG. 3 illustrates a second embodiment of the present invention.

### DETAILED DESCRIPTION

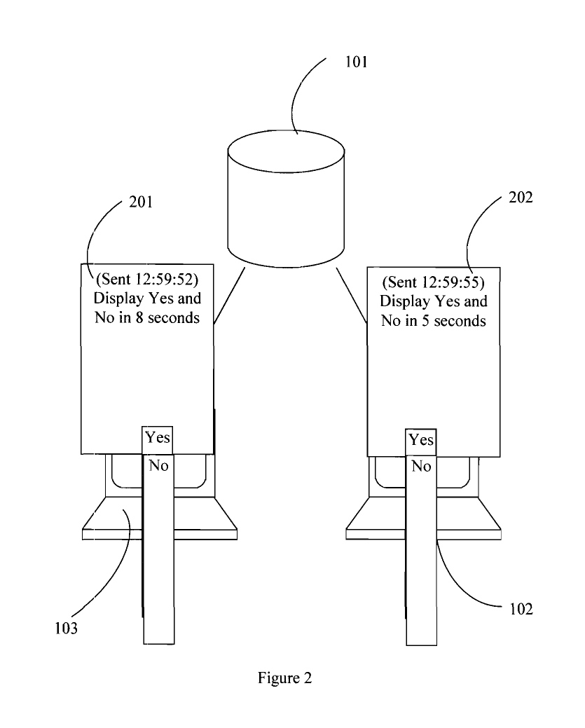

FIG. 2 presents a first embodiment of the invention. Client screens 102, 103 poll the server 101 every five seconds to see what information to display. Online voting server 101 wishes the results of a Yes/No voting buttons to be displayed on all client screens 102, 103 at exactly 13:00:00. Ten seconds before, at 12:59:50, when clients 102, 103 poll the server 101, server instructs them with messages 201, 202, when to display the buttons. The content of the messages 201, 202 will vary according to when the message is sent to ensure all buttons appear simultaneously.

In the first embodiment, when the message is composed by the server, it calculates the difference in time, according to its own clock, between the present time and the time the client should display the information. This time difference information is included in the messages 201, 202. On receipt of the message, clients 102 and 103 activate timers that trigger the display of the button after the delay, i.e. at exactly 13:00:00 according to the server's clock time.

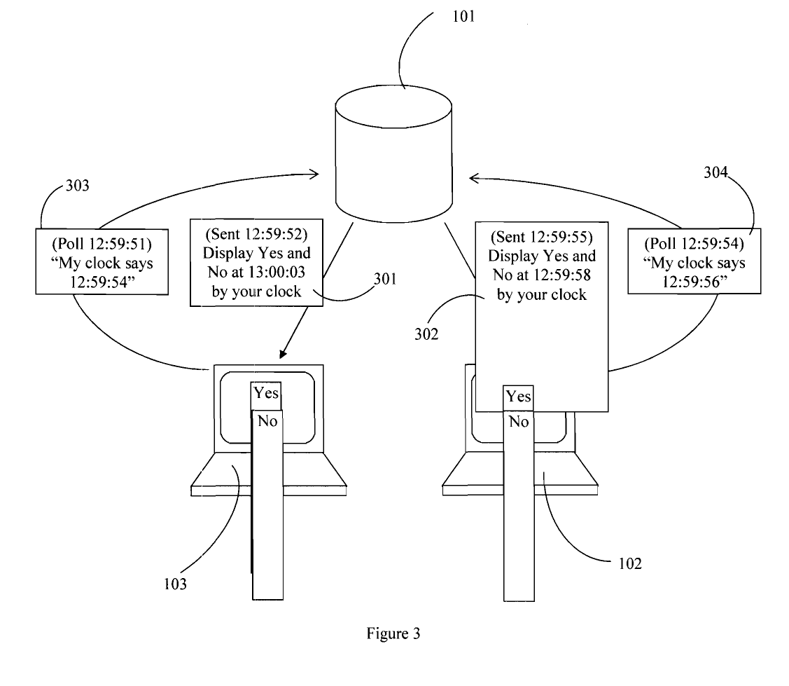

According to FIG. 3, in a second embodiment, when each client polls the server, 303, 304, it includes its clock time. When the message is composed by the server, it calculates the difference in time, according to its own clock, between the present time and the time the client should display the information. Then by comparing the client's clock time with the time on the server clock when the polling message was received, the server computes what the client's clock will be when the message is to appear. This time information is included in the messages 301, 302. Each client, 102, 103, on receipt of the message, activates a time-based that trigger according to its local clock the display of the button at exactly 13:00:00 according to the server's clock time.

1. A method of sending a message between an Internet connectable server and client, the message to be displayed at a particular time, the method comprising the steps of:
the server receiving a first polling message from a first client;
the server, in response to receiving the first polling message, calculates a first time delay for a first message, and sends the first message to the first client, the first message including an indication of the first time delay; and
the first client, in response to receiving the first message, causes the first message to be displayed on expiry of the first time delay.

2. A method as claimed in claim 1, wherein the first time delay is calculated as the difference between a time to display the first message and a time of composition of the first message.

3. A method as claimed in either claim 1, wherein the first polling message includes an indication of the first client's local time, and the first time delay is calculated as the difference between a time to display the first message and the indication of the first client's local time.

4. A method as claimed in claim 1, further comprising the steps of:
the server receiving a second polling message from a second client;
the server, in response to receiving the second polling message, calculates a second time delay for a second message, and sends the second message to the second client, the second message including an indication of the second time delay;
the second client, in response to receiving the second message, causes the second message to be displayed on expiry of the second time delay.

5. A method as claimed in claim 4, wherein the second time delay is calculated as the difference between a time to display the second message and a time of composition of the second message.

6. A method as claimed in claim 4, wherein the second polling message includes an indication of the second client's local time, and the second time delay is calculated as the difference between a time to display the second message and the indication of the second client's local time.

7. A method as claimed in claim 1, wherein the client is a web browser.

8. An Internet connectable server, for sending a message to a client, the message to be displayed at a particular time, the Internet connectable server comprising
an input for receiving a first polling message from a first client;
a processor, configured for calculating a first time delay for a first message; and
an output for transmitting the first message, including an indication of the first time delay, to the first client.

9. An Internet connectable server as claimed in claim 8, wherein the first time delay is calculated as the difference between a time to display the first message and a time of composition of the first message.

10. An Internet connectable server as claimed in claim 8, wherein the first polling message includes an indication of the first client's local time, and the first time delay is calculated as the difference between a time to display the first message and the indication of the first client's local time.

11. An Internet connectable server as claimed in claim 8, wherein the processor is also for receiving a second polling message from a second client; the processor is also configured for calculating a second time delay for a second message; and the output is also for transmitting the second message, including an indication of the second time delay, to the second client.

12. An Internet connectable server as claimed in claim 11, wherein the second time delay is calculated as the difference between a time to display the second message and a time of composition of the second message.

13. An Internet connectable server as claimed in either claim 11, wherein the second polling message includes an indication of the second client's local time, and the second time delay is calculated as the difference between a time to display the second message and the indication of the second client's local time.

14. An Internet connectable client, for receiving a message from a server, the message to be displayed at a particular time, the Internet connectable client comprising
an output for transmitting a polling message to the server;
an input for receiving a message from the server, the message including a predetermined time delay; and
a processor, configured to cause the message to be displayed on expiry of the predetermined time delay.

15. An Internet connectable client as claimed in claim 14, wherein the polling message includes an indication of the client's local time.

16. An Internet connectable client as claimed in claim 14, being a web browser.
